(19) United States
(12) Patent Application Publication
(10) Pub. No.: US 2026/0063982 A1
(43) Pub. Date: Mar. 5, 2026

(54) Silicone Projection Screen

(71) Applicant: Arovia, Inc., Houston, TX (US)

(72) Inventors: Hang Kuen Yip, Hong Kong (HK); Qijia Fu, Hong Kong (HK); Jifan Li, Hong Kong (HK); Shengliang Zhu, Houston, TX (US); Alexander Wesley, Houston, TX (US)

(21) Appl. No.: 19/106,763

(22) PCT Filed: Aug. 29, 2023
(86) PCT No.: PCT/CN2023/115594

§ 371 Date: Feb. 26, 2025

(30) Foreign Application Priority Data
Aug. 31, 2022 (CN) 202211059861.8
Aug. 31, 2022 (CN) 202222326781.6

(51) Int. Cl. G03B 21/58; G03B 21/62

(52) U.S. Cl. CPC G03B 21/58; G03B 21/62

(57) ABSTRACT

A silicone projection screen, comprised of a first surface, a second surface and a plurality of tiny curved structures. The second surface is relative to the first surface. These tiny curved structures are formed on the first surface. Materials for silicone projection screens include liquid silicones and/or solid silicones. After the silicone projection screen is compressed with 2 kg weight for 24 hours after folding in half 4 times, the spread-out silicone projection screen fully recovers from any creases within 30 min and is completely flat. The shape of the silicone projection screen is approximately rectangular. The silicone projection screen is foldable.

### TECHNICAL FIELD

The present invention relates to the field of projection screens, in particular with respect to a silicone projection screen that can be folded.

### BACKGROUND

Today, projectors that use light projection to display images can be widely seen in, business, education, and engineering settings, as well as home and professional theaters. With the advancement of optical technology and electrical technology, projectors have become increasingly miniaturized and portable, allowing people to use them in outdoor activities such as camping, etc.

To provide a high-quality projection image, the quality of the projection screen is one of the important factors, in addition to the quality of the projector's optics. If the projection screen is not flat enough, its color is inhomogeneous, or the surface is too smooth, the image quality will be affected. Foldable soft screens were developed to improve portability. However, existing screens are prone to wrinkles and creases after folding, resulting in reduced image quality. On the other hand, rolling up the screen for storage will sacrifice portability. Therefore, those skilled in the art have long wanted to solve the problem of how to provide a portable projection screen that does not affect the projected image quality.

U.S. Pat. No. 9,857,674 B2 discloses a foldable display device: U.S. Pat. No. 10,156,781 B2 discloses a foldable, portable display device.

Referenced Patents: R1, U.S. Pat. No. 3,144,889A; R2, U.S. Pat. No. 3,560,088A; R3, U.S. Pat. No. 4,323,301A; R4, U.S. Pat. No. 4,432,619A; R5, U.S. Pat. No. 5,510,862A; R6, U.S. Pat. No. 5,838,493A; R7, JP2000010196A; R8, U.S. Pat. No. 6,034,717A; R9, U.S. Pat. No. 6,191,886B1; R10, U.S. Pat. No. 6,466,369B1; R11, JP2003101909A; R12, DE20302079U1; R13, U.S. Pat. No. 6,637,896B2; R14, US20040057109A1; R15, DE10305497A1; R16, U.S. Pat. No. 6,873,460B1; R17, US20050174638A1; R18, US20060077356A1; R19, US20060234784A1; R20, US20060232610A1; R21, US20070171375A1; R22, JP2007264282A; R23, JP2008065018A; R24, NL1033809C2; R25, US20090190212A1; R26, US20100007950A1; R27, US20100045569A1; R28, JP2011095303A; R29, US20110132557A1; R30, US20110242501A1; R31, JP2012118548A; R32, U.S. Pat. No. 8,313,199B2; R33, JP2013142852A; R34, U.S. Pat. No. 3,144,899A; R35, U.S. Pat. No. 4,017,152A; R36, JPS5339552Y2; R37, FR2552896B1; R38, JPS62159134A; R39, JPH02282237A; R40, JPH04275538A; R41, JP2924410B2; R42, JPH07113999A; R43, JPH09230503A; R44, JP3086220B1; R45, CN2396678Y; R46, JP4148791B2; R47, JP2004279998A; R48, JP2005331898A; R49, DE202004015139U1; R50, JP2006227088A; R51, JP2008070749A; R52, JP2008070748A; R53, U.S. Pat. No. 7,416,316B2; R54, CN201025940Y; R55, JP5012420B2; R56, CN104076590B; R57, JP2015049483A; R58, CN106207483A; R59, U.S. D828433S1; R60, U.S. D869543S1; R61, TWI723056B; R62, CN111338173A; R63, CN113093459A.

### SUMMARY

To solve the aforementioned problem of image quality and overcome the shortcomings of the prior art, the object of the present invention is to provide a silicone projection screen that is wrinkle-resistant, very portable, and able to maintain good surface quality when unfolded.

One embodiment of the present invented silicone projection screen is comprised of a first surface, a second surface and a plurality of tiny curved structures. The second surface is relative to the first surface. These tiny curved structures are formed on the first surface. Materials for the silicone projection screens include liquid silicones and/or solid silicones. After the silicone projection screen is compressed with 2 kg weight for 24 hours after folding in half 4 times, the spread-out silicone projection screen fully recovers from any creases within 30 min and is completely flat. The shape of the silicone projection screen is approximately rectangular.

In the embodiment of the present invention, the surface roughness of the aforementioned first surface is between 0.6 and 0.9 microns.

In the embodiment of the present invention, the thickness of the aforementioned silicone projection screen is between 0.2 and 0.5 mm.

In the embodiment of the present invention, when a projection light of 1000 lux brightness is shined onto the aforementioned silicone projection screen in an environment with 500 lux ambient brightness, the contrast of the silicone projection screen is not less than 6.

In the embodiment of the present invention, the color of the aforementioned silicone projection screen is gray.

In the embodiment of the present invention, the density of the aforementioned silicone projection screen is between 1 and 1.3 g/cm³.

Another embodiment of the present invented silicone projection screen is comprised of liquid silicones and/or solid silicones. The silicone projection screen is further comprised of light diffusion additive and diluted black dye. After the silicone projection screen is compressed with 2 kg weight for 24 hours after folding in half 4 times, the spread-out silicone projection screen fully recovers from any creases within 30 min and is completely flat.

In the embodiment of the present invention, the thickness of the aforementioned silicone projection screen is between 0.2 and 0.5 mm.

In the embodiment of the present invention, the ultimate tensile strength of the aforementioned silicone projection screen is between 1.5 and 9.3 MPa.

In the embodiment of the present invention, the resilience of the aforementioned silicone projection screen is between 59% and 85%.

In the embodiment of the present invention, the Shaw A hardness of the aforementioned silicone projection screen is between 20 to 60.

In the embodiment of the present invention, the transmittance of the aforementioned silicone projection screen is between 30% to 95%.

In the embodiment of the present invention, when a projection light of 1000 lux brightness is shined onto the aforementioned silicone projection screen in an environment with 500 lux ambient brightness, the contrast of the silicone projection screen is not less than 6.

In the embodiment of the present invention, the material of the aforementioned silicone projection screen may also include a first solid silicone and a different second solid silicone. When the relative weight of the first solid silicone is 100 parts, the relative weight of the second solid silicone is between of 3 to 300 parts. The ultimate tensile strength of the first solid silicone is between 1.5 to 2.1 MPa, and the ultimate tensile strength of the second solid silicone is between 9.3 to 9.5 MPa Range.

In the embodiment of the present invention, the material of the aforementioned silicone projection screen is further comprised of a third solid silicone. The first solid silicone, the second solid silicone and the third solid silicone are different from each other. When the relative weight of the first solid silicone is 100 parts, the relative weight of the third solid silicone is between 1 to 6 parts. The ultimate tensile strength of the third solid silicone is between 6.9 to 8.4 MPa.

In the embodiment of the present invention, the material of the aforementioned silicone projection screen is comprised of foamed liquid silicones and/or solid silicones.

In the embodiment of the present invention, the density of the aforementioned silicone projection screen is between 1 and 1.3 g/cm³.

Another embodiment of the present invented silicone projection screen is comprised of liquid silicone, solid silicone, foamed liquid silicone, or foamed solid silicone. The silicone projection screen is further comprised of a first surface, a second surface. The second surface is relative to the first surface. A plurality of tiny curved structures are formed on the first surface to create roughness on the surface. The silicone projection screen is formed by extrusion via injection, calendaring, or compression. After extrusion to validate the wrinkle resistance, the silicone projection screen is compressed with 2 kg weight for 24 hours after folding in half 4 times, the spread-out silicone projection screen fully recovers from any creases within 30 min and is completely flat.

Based on the above information, the silicone projection screen proposed in the embodiments of the present invention has an anti-wrinkle effect. The first surface can recover from creases and become flat again after the silicone projection screen is folded in half 4 times. The invented silicone projection screen is suitable for compact folded storage.

### BRIEF DESCRIPTION OF THE DRAWINGS

The following drawings describe the embodiments of the present invention in more details, wherein:

FIG. 1 is a three-dimensional view of a projection screen in an embodiment of the present invention;

FIG. 2 is a top view of a projection screen in an embodiment of the present invention:

FIG. 3 is a section view of the profile illustrated according to the cut line 2 in FIG. 2;

FIG. 4 is a section view of a partially enlarged profile according to FIG. 3:

FIG. 5 shows a projection screen and a projector in an embodiment of the present invention:

FIG. 6 shows a projection screen and a projector in another embodiment of the present invention:

FIG. 7 shows a spread-out projection screen sample 30 min after released from compression under weights;

FIG. 8 shows another spread-out projection screen sample 30 min after released from compression under weights;

FIG. 9 shows a few spread-out projection screen 30 min after released from compression under weights: And,

FIG. 10 shows the few spread-out projection screen samples 30 min after released from compression under weights.

### DETAILED DESCRIPTION

The present invention is described in further detail below in conjunction with the accompanying drawings and specific embodiments.

In one embodiment of the present invention, the silicone projection screen is comprised of one or multiple liquid silicone materials, or one or multiple solid silicone materials. The silicone projection screen is foldable. The silicone projection screen also includes light diffusion additive as well as diluted black dye. The silicone screen manufacturing process is consisted of the mixing and the forming process.

The material of the light diffusion additive may be titanium dioxide (titania) powder, either transparent or translucent polymer, or either transparent or translucent silicone. The light diffusion additive may be added to the silicone during the mixing process, so that the silicone projection screen has a better light transmission and reflection effect. Further, because the silicone projection screen has the light diffusion additive, when the projector projects an image or video to the silicone projection screen during rear projection, the center bright spot (hotspot) is minimized. In other embodiments, the silicone projection screen having a light diffusion additive may also be used for front projection, and will minimize the hotspot as well. The mixing process includes mixing with a rotation mixer, two-roller grinding mill, or a three-roller grinding mill.

During the mixing process, concentrated black dye can also be added to the silicone to make the silicone projection screen appear gray. When the projector projects onto the gray silicone projection screen, the silicone projection screen can present a vivid and high contrast image.

Specifically, in the silicone projection screen of the present embodiment, when the relative weight of the liquid silicones and/or solid silicones is 100 parts, the relative weight of the light diffusion additive is 2 parts, and the weight of the concentrated black dye is not less than 0.02 parts. With this combination, the silicone projection screen can achieve a good light transmission and reflection effect, minimum hotspot, and the appropriate color for the projected image and video.

In the present embodiment, the forming process includes compression molding. After the mixing process, the raw solid silicone or the raw liquid silicone will be extruded or laid into the compression mold to form the silicone screen. In other embodiments, the forming process can be either injection molding or calendaring. In other words, the different embodiments can be manufactured with one, two, or all three of the manufacturing processes (compression molding, injection molding, and calendaring), from liquid silicone, solid silicone, or a combination of both.

After the silicone projection screen of the present embodiment is compressed with 2 kg weight for 24 hours after folding in half 4 times, the spread-out silicone projection screen fully recovers from any creases within 30 min and is completely flat. Therefore, the silicone projection screen of the present embodiment is suitable for compact storage, and the folding will not affect the screen's flatness during use.

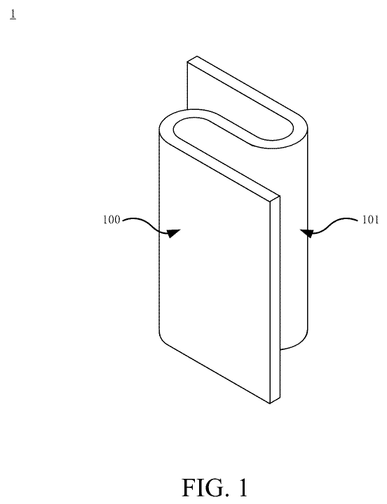

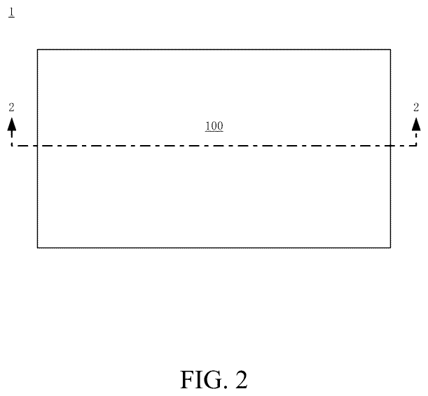

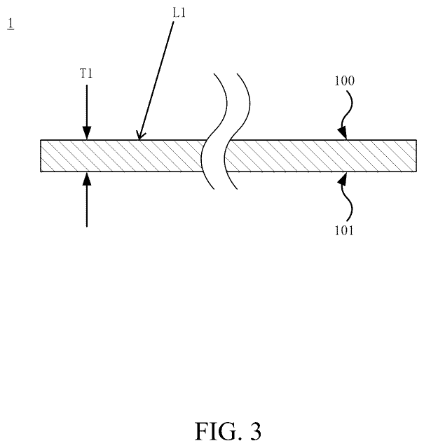

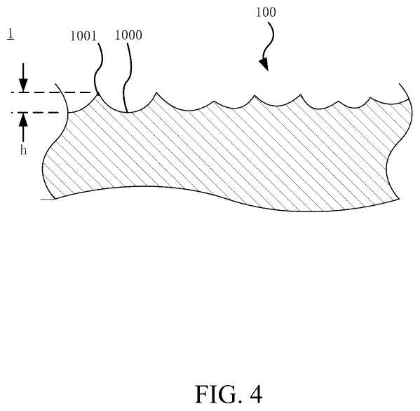

FIG. 1 is a three-dimensional view of a projection screen in an embodiment of the present invention: FIG. 2 is a top view of a projection screen in an embodiment of the present invention; FIG. 3 is a section view of the profile illustrated according to the cut line 2 in FIG. 2: FIG. 4 is a section view of a partially enlarged profile according to FIG. 3. Specifically, FIG. 1 magnified the thickness of the silicone projection screen for illustration purposes, and should not be considered as an accurate representation of the shape or the size of the present invention. In one embodiment of the present invention, silicone projection screen 1 is foldable. The silicone projection screen 1 is comprised of a first surface 100, a second surface 101 and a plurality of tiny surface structures 1000. The first surface 100 is relative to the second surface 101, and these tiny surface structures 1000 are formed on the first surface 100 to achieve the desired roughness.

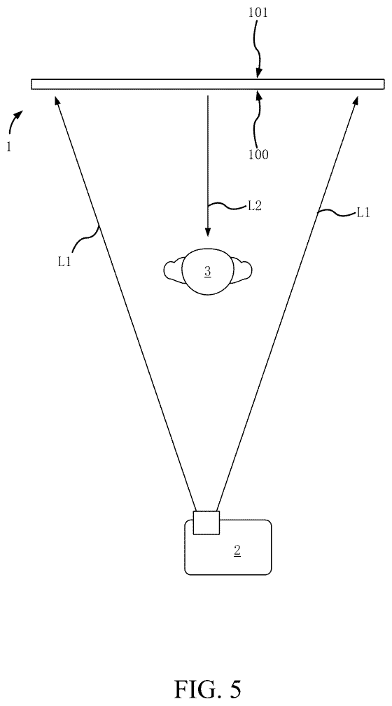

FIG. 5 shows a projection screen and a projector in an embodiment of the present invention during front projection. Projector 2 projects an image to the first surface 100, enabling a user 3 to observe the image near the side of the first surface 100. In this front projection embodiment, the first surface 100 of the silicone projection screen 1 serves as the image displaying surface. The silicone projection screen has a plurality of tiny surface structures 1000, allowing the displayed image to have a good view angle to display a good quality image.

In the present embodiment, the material of the silicone projection screen 1 includes liquid silicones and/or solid silicones. For example, in an embodiment of the present invention, the silicone projection screen 1 can be made from at least one liquid silicone through the forming process of injection molding. In another embodiment of the present invention, the silicone projection screen 1 can be made from at least one solid silicone through the forming process of calendaring. Specifically, raw silicone passes through multiple rollers during the calendaring process. These rollers apply pressure and heat to the raw silicone to form the sheet-like silicone projection screen. In another embodiment of the present invention, the silicone projection screen 1 can be made from at least one solid silicone through the forming process of compression molding. In another embodiment of the present invention, the silicone projection screen 1 can be made from at least one solid silicone through the forming process of injection molding.

After extrusion to validate the wrinkle resistance, the silicone projection screen of the present embodiment is compressed with 2 kg weight for 24 hours after folding in half 4 times, the spread-out silicone projection screen fully recovers from any creases within 30 min and is completely flat. Therefore, the silicone projection screen of the present embodiment is suitable for compact storage, and the folding will not affect the screen's flatness during use.

In the present embodiment, the first surface 100 of the silicone projection screen 1 does not have other surfaces on top of it, and the second surface 101 of the silicone projection screen 1 does not have other surfaces on top of it as well.

Referring to FIG. 5, when the first surface 100 of the silicone projection screen 1 is the image displaying surface, the projector projects an image or video to the first surface 100 to achieve a high-quality projection. The first surface 100 of the silicone projection screen 1 has a plurality of tiny curved structures 1000 so that the first surface 100 can provide an excellent light scattering effect while not attracting dust.

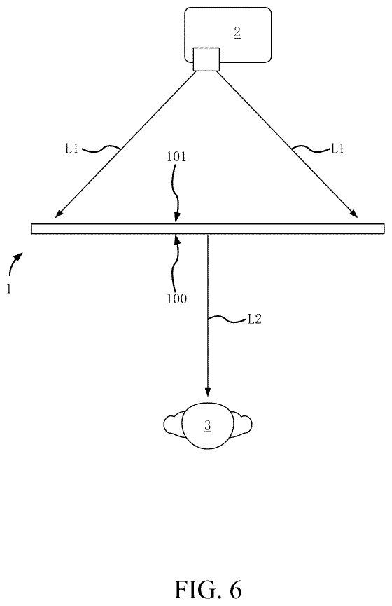

FIG. 6 shows a projection screen and a projector in another embodiment of the present invention during rear projection. In this embodiment, projector 2 projects onto the second surface 101. The projected light passes through the silicone projection screen 1, and the user 3 observes the projected image on the side of the first surface 100. The first surface 100 has a plurality of tiny curved structures 1000 so that the first surface 100 has an excellent light scattering effect to achieve a good image quality.

Referring now to FIG. 3, on the first surface 100, the tiny curved structures 1000 form a plurality of raised structures (peaks) 1001. The peaks 1001 on the first surface 100 have an average height of “h”. The height “h” can exceed 0.3 microns, which enables the first surface 100 to have an excellent light scattering effect and thereby having a wide viewing angle for the projected image.

These tiny curved structures 1000 on the first surface 100 may be made by means of a mold. After the mixing of the liquid or solid silicone, the raw silicone is extruded into a mold to form a silicone projection scree 1 with a first surface 100 and a second surface 101.

In the mold to form the silicone projection screen 1, the mold surface to form the first surface 100 has a plurality of tiny curved structures. The mold surface to form the second surface 101 is a smooth surface. In another embodiment, the mold surface to form the second surface 101 also has a plurality of tiny curved structures, so that both of the first surface 100 and the second surface 101 of the silicone projection screen 1 have a plurality of tiny curved structures. This silicone projection screen can provide excellent light scattering effects on both surfaces.

Further, the surface roughness of the first surface 100 of the present embodiment is between 0.6 to 0.9 microns. Specifically, on the first surface 100, the distance between two peaks in the tiny surface structures 1000 is between 0.6 to 0.9 microns. Thus, the first surface 100 can provide a projected image with a good viewing angle.

Further, in the present embodiment, the first surface 100 can go through a silicone oil spray process after the forming process. The oil spray on the first surface 100 further reduces the hotspot.

In an embodiment of the present invention, the material of the silicone projection screen 1 is further comprised of light diffusion additive. The light diffusion additive can be a white powder such as titanium dioxide (titania), either transparent or translucent polymer, or either transparent or translucent polymer silicone. The transparent or translucent polymer can include, but not limited to, polycarbonate (PC). In other embodiments, the transparent or translucent polymer can include polyethylene terephthalate (PET), poly (methyl methacrylate) (PMMA), or polyvinyl chloride (PVC). With these light diffusion additives, the silicone projection screen 1 can achieve a high-quality projected image with wide viewing angle with minimum hotspots.

In an embodiment of the present invention, the material of the silicone projection screen 1 further is comprised of a black dye, so that the silicone projection screen 1 is manufactured gray to provide a high contrast projected image. For example, in the silicone projection screen 1 of the present embodiment, when the relative weight of the silicone is 100 parts, the relative weight of the light diffusion additive is 2 parts, and the relative weight of the black dye is not less than 0.02 parts, so that the silicone projection screen 1 can achieve a good projected image.

In an embodiment of the present invention, the material of the silicone projection screen 1 may further include an anti-wrinkle additive. The main component of anti-wrinkle additives is clay-like materials. When the relative weight of the silicone is 100 parts, the relative weight of the anti-wrinkle additive is 1 parts. By adding the anti-wrinkle additives, the silicone projection screen 1 will have better wrinkle resistance. After being folded and stored for a long time, the unfolded silicone projection screen 1 can fully recover from any wrinkles or creases, and provide a flat projection surface.

Further, in an embodiment of the present invention, the weight of the silicone projection screen 1 is between 250 to 325 g when the screen size is 0.2 m². The density of silicone projection screen 1 is between 1 to 1.3 g/cm³. Therefore, the silicone projection screen 1 is convenient to carry. However, the present invention is not limited to the aforementioned weight. In other embodiments, the silicone projection screen 1 may be designed to have a larger area and hence weighs more as needed.

In an embodiment of the present invention, the thickness Tl of the silicone projection screen 1 is between 0.2 and 0.5 mm. The silicone projection screen 1 is easy to fold and store while still presenting a high-quality projected image. In the present embodiment, the silicone projection screen 1 is used for front projection. Projection light L1 is directly projected onto the first surface 100, while the viewer also looks at the first surface 100 to view the image.

Referring to FIG. 6, in other embodiments, the silicone projection screen 1 is used for rear projection. Projection light L2 is projected onto the second surface 101, while the viewer looks at the first surface 100 to view the image. Further, the total transmittance of the silicone projection screen 1 of the present embodiment is 90% so that a high-quality projected image can be achieved in rear projection. In some other embodiments of the present invention, the total transmission of the silicone projection screen 1 is between 30% and 95% to achieve a high-quality projected image.

When a projection light L2 of 1000 lux brightness is shined onto the silicone projection screen 1 in an environment with 500 lux ambient brightness, the contrast of the silicone projection screen is not less than 6. In other words, when the silicone projection screen is used in rear projection mode, the contrast of the picture it presents is no less than 6.

In detail, the contrast CR is calculated as follows:

$$C R = \frac{T \times {L}_{p} + R \times {L}_{a}}{R \times {L}_{a}}$$

wherein T is the transmittance of the silicone projection screen: R is the reflectivity of the silicone projection screen: Lₚ is the projected illuminance: La is the ambient illuminance. The contrast of the silicone projection screen 1 of the present embodiment is no less than 6 when presenting the picture to achieve a high-quality projected image.

In an embodiment of the present invention, the ultimate tensile strength of the silicone projection screen 1 is between 1.5 and 9.3 MPa. Thus, the silicone projection screen 1 of the present embodiment may be reasonably stretched and extended to form a flat surface for projection without causing damage.

The resilience of the silicone projection screen 1 of the present embodiment is between 59% and 85%. The resilience described herein is the percentage of elastic potential energy that can be absorbed by this material without permanent deformation. Since the silicone projection screen of the present embodiment has a high resilience, the silicone projection screen recovers completely from any creases after folding.

On the other hand, the Shore A hardness of the silicone projection screen 1 of the present embodiment is between 20 and 60. The silicone projection screen 1 is soft and has excellent elastic performance, making it suitable for folding and storage. Silicone projection screen 1 is also resilient enough to provide a flat surface without creases.

In another embodiment of the present invention, the material of the silicone projection screen 1 may include a first solid silicone and a second solid silicone. The first solid silicone and the second solid silicone are different. When the relative weight of the first solid silicone is 100 parts, the relative weight of the second solid silicone is between 33 and 300 parts. The ultimate tensile strength of the first solid silicone is between 1.5 and 2.1 MPa. The ultimate tensile strength of the second solid silicone is between 9.3 and 9.5 MPa. Thus, the silicone projection screen 1 of the present embodiment can be reasonably stretched and extended to form a flat surface for projection without causing damage.

At the same time, the resilience of the first solid silicone is between 65% and 85%, and the resilience of the second solid silicone is between 25% and 40%. By mixing the first solid silicone and the second solid silicone together for manufacturing, the silicone projection screen 1 can recover from any creases after being folded and compressed under weights.

In the present embodiment, the first solid silicone and the second solid silicone is mixed via a two-roller grinding mill. The mixture is then fed into a calendaring machine to be heated and flattened to form the silicone projection screen 1. For example, the solid silicone mixture can be heated up to 150 Celsius degrees. In other embodiments, the calendaring temperature can vary between 100 and 200 Celsius degrees.

In an embodiment of the present invention, the material of the silicone projection screen may further include a third solid silicone. The first solid silicone, the second solid silicone and the third solid silicone are different from each other. When the first solid silicone relative weight is 100 parts, the relative weight of the third solid silicone is between 1 and 6 parts.

The ultimate tensile strength of the third solid silicone falls in the range of 6.9 to 8.4 MPa. Thus, the silicone projection screen 1 still has a reasonable ultimate tensile strength, and can be reasonably stretched and extended to form a flat surface for projection without causing damage.

The third solid silicone can strengthen the anti-wrinkle ability of the silicone projection screen 1. The resilience of the third solid silicone is between 55% and 66%. Compared to the first solid silicone, the third solid silicone has a lower resilience. Compared to the second solid silicone, the third solid silicone has a higher resilience. Therefore, by adding a third solid silicone, it is possible to improve the anti-wrinkle ability of the silicone projection screen 1 so that the silicone projection screen can recover from creases faster after folding.

Silicone projection screen 1 includes a first solid silicone, a second solid silicone and a third solid silicone. The three-silicone combination is mixed through a two-roller grinding mill, and then formed through the calendaring process. The calendaring process heats, compresses and flattens the mixture to form a silicone projection screen 1 with appropriate thickness.

On the other hand, the elongation at break of the first solid silicone of the present embodiment is between 50% and 300%, the elongation at break of the second solid silicone is between 480% and 700%, and the elongation at break of the third solid silicone is between 310% and 400%. Therefore, the silicone projection screen 1 has excellent toughness and elasticity, allowing the silicone projection screen to fold and unfold to form a flat surface.

In the present embodiment, the Shaw A hardness of the first solid silicone is no less than 33, that of the second solid silicone is no higher than 52, that of the third solid silicone no higher than 52 as well. For example, in one embodiment of the present invention, the Shaw A hardness of the first solid silicone is 33, that of the second solid silicone is 52, that of the third solid silicone is also 52, so that the silicone projection screen 1 will have the desired softness.

In another embodiment of the present invention, the material of the silicone projection screen 1 may include a foamed liquid silicone or foamed solid silicone. Specifically, the material of the silicone projection screen 1 can include silicone, a foaming agent, and a curing agent. The material is calendared, compression molded or injection molded to form the silicone projection screen 1.

In the present embodiment, the density of the silicone projection screen 1 is between 300 and 700 kg/m³. Therefore, the silicone projection screen 1 is convenient to carry and will not crack after folding and compressing, while also having good durability and wrinkle resistance.

The material of the silicone projection screen 1 of the present embodiment may further include light diffusion additive, black dye, and anti-wrinkle additive. Light diffusion additive such as titanium dioxide (titania), either transparent or translucent polymer, or either transparent or translucent polymer silicone. The absolute weight percentage of the light diffusion additive in the material of the silicone projection screen 1 is between of 0.5% and 2%. Silicone projection screen 1 with the light diffusion additive will create sufficient reflectivity on the first surface 100 for front projection. The light diffusion additive can provide good scattering capability in the silicone projection screen 1 and is therefore also suitable for application in rear projection to minimize hotspot.

Black dye can change the silicone projection screen 1 to an appropriate color for a high-quality projected image. Anti-wrinkle additives can further enhance the anti-wrinkle ability of silicone projection screen 1.

Silicone projection screen 1 may further include a rough surface structure. Additional processing can form a rough surface structure on the silicone projection screen 1 of the present embodiment 1 to achieve a good light scattering effect, thereby creating a larger viewing angle during projection.

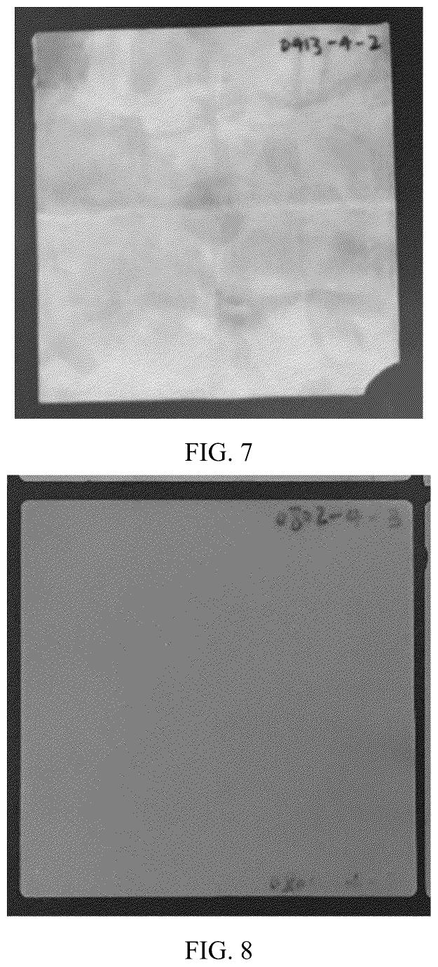

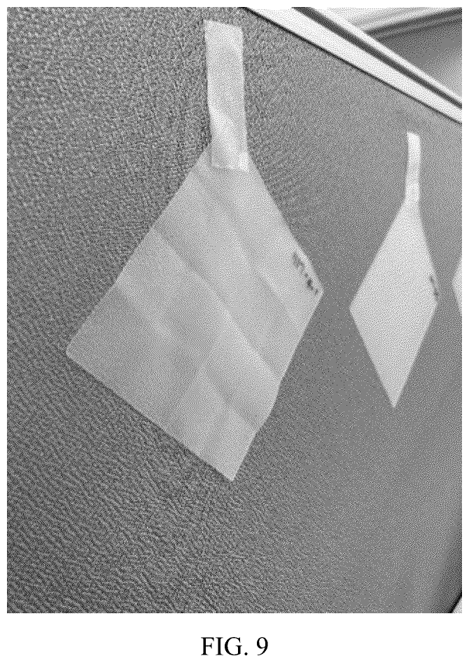

Several embodiments of the present invention are compared side by side in FIG. 7 and FIG. 8. FIG. 7 and FIG. 9 both show a spread-out projection screen sample 30 min after released from compression under weights. The silicone projection screen 1 in FIG. 7 was made from a solid silicone with a resilience of 37%, and it still showed wrinkles 30 min after it was released from compression under 2 kg weight for 24 hours after folding in half 4 times. The silicone projection screen 1 in FIG. 8 was made from the first aforementioned solid silicone and the second aforementioned solid silicone, mixed with equal weight percentage to a combined resilience of 61%. 61% is between the aforementioned range of 59% and 85%. The silicone projection screen 1 in FIG. 8 completely recovered from wrinkles 30 min after it was released from compression under 2 kg weight for 24 hours after folding in half 4 times.

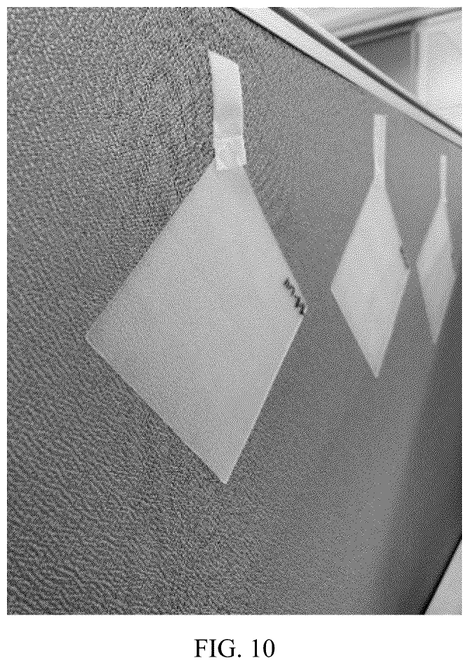

Several more embodiments of the present invention are compared side by side in FIG. 9 and FIG. 10. FIG. 9 and FIG. 10 shows a few spread-out projection screen 30 min after released from compression under weights. The silicone projection screen 1 in FIG. 9 was made from a liquid silicone with a resilience of 34%, and it still showed wrinkles 30 min after it is released from compression under 2 kg weight for 24 hours after folding in half 4 times. The silicone projection screen 1 in FIG. 10 was made from a liquid silicone with a resilience of 61%. 61% is between the aforementioned range of 59% and 85%. The silicone projection screen 1 in FIG. 10 completely recovers from wrinkles 30 min after it is released from compression under 2 kg weight for 24 hours after folding in half 4 times.

From the comparison, when the resilience of the embodiments of the present invention is between 59% and 85%, the silicone projection screen can fully recover from wrinkles within 30 min of releasing from its folded state.

The above embodiments are only preferred embodiments of the present invention, and do not limit the scope of the present invention. Any modifications, equivalent substitutions, and improvements within the spirit and principles of the present invention should be included within the scope of the protection of the present invention.

1. A method for testing the wrinkle resistance of sheet silicone material, comprising:
folding the sheet material in half 4 times,
compressing the folded sheet material under a 2 kg weight for 24 hours,
unfolding and laying the sheet material on a flat surface, and
observing the disappearance of wrinkles in the unfolded material after 30 minutes as a successful test.

2. A foldable, wrinkle-free silicone projection screen that passes the method of claim 1, comprising:
a first surface,
a second surface with respect to the first surface,
a plurality of tiny surface structures formed on the first surface, and
comprising mixing and extruding one or multiple materials from liquid silicone, solid silicone, foamed liquid silicone, and foamed solid silicone.

3. The silicone projection screen of claim 2, further comprising:
one or more light diffusion additives, and
a black dye.

4. The silicone projection screen of claim 2, wherein said materials further comprising:
a first solid silicone having an ultimate tensile strength in the range of 1.5 to 2.1 MPa,
a different second solid silicone having an ultimate tensile strength in the range of 9.3 to 9.5 MPa, wherein
the relative weight portion of the first silicone material is 100 parts and that of the second silicone material is in the range of 33-300 parts.

5. The silicone projection screen of claim 4, wherein said materials further comprising:
a different third solid silicone having a resilience in the range of 55% and 66%, wherein
the relative weight portion of the first silicone material is 100 parts and that of the third silicone material is in the range of 1-6 parts.

6. The silicone projection screen of claim 2, claim 3, or claim 4, wherein said silicone projection screen is gray.

7. The silicone projection screen according of claim 2, claim 3, or claim 4, wherein the density of said silicone projection screen is in the range of 1 to 1.3 g/cm³.

8. The silicone projection screen of claim 2, claim 3, or claim 4, wherein the surface roughness of said first surface is in the range of 0.6 to 0.9 microns.

9. The silicone projection screen of claim 2, claim 3, or claim 4, wherein the thickness of said silicone projection screen is in the range of 0.2 to 0.5 mm.

10. The silicone projection screen of claim 2, claim 3, or claim 4, wherein the ultimate tensile strength of said silicone projection screen is in the range of 1.5 to 9.3 MPa.

11. The silicone projection screen of claim 2, claim 3, or claim 4, wherein the resilience of said silicone projection screen is in the range of 59% to 85%.

12. The silicone projection screen of claim 2, claim 3, or claim 4, wherein the Shore A hardness of said silicone projection screen is in the range of 20 to 60.

13. The silicone projection screen of claim 2, claim 3, or claim 4, wherein the light transmittance of said silicone projection screen is in the range of 30% to 95%.

14. The silicone projection screen of claim 2, claim 3, or claim 4, wherein the contrast of said silicone projection screen is equal to or greater than 6, when measured by shining a projection light of 1000 lux brightness onto the silicone projection screen in an environment with 500 lux ambient brightness.

15. The silicone projection screen of claim 2, claim 3, or claim 4, wherein said silicone projection screen further comprising:
anti-wrinkle additives.

16. A foldable, wrinkle-free silicone projection screen that passes the method of claim 1, comprising
a first surface,
a second surface with respect to the first surface,
a plurality of tiny surface structures formed on the first surface,
a black dye,
light diffusion additives, and
comprising mixing and extruding one or multiple materials from liquid or solid silicones.

17. A foldable, wrinkle-free silicone projection screen that passes the method of claim 1, comprising
a first surface,
a second surface with respect to the first surface,
a plurality of tiny surface structures formed on the first surface and the second surface,
either liquid or solid silicone,
light diffusion additives, and
a black dye.
